(19) United States
(12) Patent Application Publication
(10) Pub. No.: US 2004/0011057 A1
(43) Pub. Date: Jan. 22, 2004

(54) Ultra-low emission power plant

(75) Inventor: Dave J. Huber, Jupiter, FL (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 10/196,008

(22) Filed: Jul. 16, 2002

(51) Int. Cl. F02C 3/28

(52) U.S. Cl. 60/781; 60/39.12

(57) ABSTRACT

An integrated gasification power generating system (100) includes an oxygen separator (1) for providing an oxygen rich gas stream (2) from an oxygen containing gaseous mixture such as air (13). The oxygen separator (1) provides an oxygen stream (2) preferably including at least 99% oxygen. The system includes a gasifier (25) for generating a synthesis gas and a combustor (21) for combusting a mixture including the oxygen rich gas stream (20), a steam flow (23) and the synthesis gas (22) or a product derived therefrom, to produce thermal energy.

### STATEMENT REGARDING FEDERALLY SPONSORED RESEARCH OR DEVELOPMENT

Not applicable.

### FIELD OF THE INVENTION

This invention relates generally to high efficiency and low emission power generation systems and a method of operating such systems.

### BACKGROUND OF THE INVENTION

Coal and other solid fuels have been traditionally used for power generation using a Rankine Cycle in a steam power plant. The fuel is generally pulverized into small particles and then directly fired in a furnace which produces superheated steam. The superheated steam is used to generate power in a steam turbine. Such power plants are typically only 30-45% efficient on a thermal-to-electrical energy conversion basis. Furthermore, such plants emit significant quantities of solid and gaseous waste and pollutants, such as nitrogen oxides, sulfur oxides, heavy metals, carbon dioxide, and particulate matter.

New power systems operating on fossil fuels have been under development for several years. These systems are designed to increase efficiency (fuel energy conversion to electricity) and to reduce harmful emissions to the environment. More recently, strategies used to incorporate the use of coal and other solid or heavy liquid fuels into more efficient and lower emission gas turbine combined cycles have utilized a Integrated Gasification Combined Cycle (IGCC). In an IGCC, a gas turbine is fired with low-to-medium BTU synthesis gas (syngas) created in a gasifier by the partial oxidation reaction of fuel with air or oxygen in the presence of steam.

The gas turbine exhausts into a heat recovery steam generator (HRSG) that, along with the gasifier and syngas cooler, produces steam in a bottoming Rankine Cycle. Such plants have much lower emissions than the traditional steam power plants, and have the potential to deliver thermal efficiencies as high as about 50 to 55%.

However, even the most optimistic projections of IGCC emissions fall far short of the goal of an ultra-low emission power plant, as the combustion of syngases in air creates nitrogen oxides and the stack emits large amounts of carbon dioxide. Furthermore, such plants are significantly more expensive to configure as compared to traditional steam power plants.

### SUMMARY OF INVENTION

An integrated gasification power generating system includes an oxygen separator for providing an oxygen rich gas stream from a gaseous mixture including oxygen, such as air, the oxygen rich gas stream including at least 95%, and preferably at least 99% oxygen. A gasifier is provided for generating a synthesis gas from at least one fuel. A combustor is provided for combusting a mixture including the oxygen rich gas stream, a steam flow and the synthesis gas or a product derived from the synthesis gas to produce thermal energy. A structure for converting at least a portion of the thermal energy generated converts the thermal energy to another form of energy such as electrical and/or mechanical energy.

The low nitrogen content in the oxygen rich gas stream permits the combustor to operate at a combustion temperature of at least 3000° F. (1650° C.), which raises the efficiency of the system compared to conventional IGCC systems. For example, the system is adapted to provide a thermal-to-electrical energy efficiency of at least 55%.

The system utilizes a single thermodynamic cycle through utilizing its own waste heat. Conventional combined cycles require an extra thermodynamic cycle to recover waste heat that is generated, such as through use of a heat recovery steam generator (HRSG) Rankine Bottoming Cycle to recover waste from the gas turbine.

The oxygen separator can comprise an ion transport membrane (ITM) air separation unit (ASU). In this embodiment, the system can include structure for generating a fluid capable of providing refrigeration. The oxygen separator can also comprise a cryogenic air separator.

The system can include structure for heating the oxygen rich gas stream prior to combusting in the combustor. In this embodiment, the oxygen rich gas stream can be heated to a temperature of at least 800° F. (425° C.) prior to combustion in the combustor.

The system can further comprise structure for converting the synthesis gas to a converted fuel, the converted fuel comprising at least 30% hydrogen gas. The structure for converting the synthesis gas can comprise a shift reactor/pressure swing adsorber.

The system can further comprise structure for superheating the steam flow prior to combustion in the combustor, wherein said superheat temperature is at least 1000° F. (540° C.).

A method of operating an integrated gasification power generating system includes the steps of providing a steam flow and an oxygen rich gas stream, the oxygen rich gas stream including at least 95%, and preferably at least 99% oxygen. A synthesis gas is generated from at least one fuel. A mixture including the oxygen rich gas stream, the steam flow and the synthesis gas or a product derived from the synthesis gas is combusted to produce thermal energy. At least a portion of the thermal energy produced is converted by the system into another energy form.

### BRIEF DESCRIPTION OF THE DRAWINGS

A fuller understanding of the present invention and the features and benefits thereof will be accomplished upon review of the following detailed description together with the accompanying drawings, in which:

FIG. 1 illustrates a power generation system which includes an ion transport membrane for producing an oxygen rich gas stream through air separation.

FIG. 2 illustrates a power generation system which includes a cryogenic air separator for producing an oxygen rich gas stream from air.

FIG. 3 illustrates a power generation system which includes an ion transport membrane for producing an oxygen rich gas stream from air and a shift reactor/pressure swing adsorber for hydrogen gas generation from synthesis gas.

FIG. 4 illustrates a power generation system including a cryogenic air separator for producing an oxygen rich gas stream from air and a shift reactor/pressure swing adsorber for hydrogen gas generation from synthesis gas.

FIG. 5 illustrates a power generation system including an ion transport membrane for producing an oxygen rich gas stream from air, the system also providing refrigeration.

FIG. 6 illustrates a power generation system including a cryogenic air separator for producing an oxygen rich gas stream, the system also including additional oxygen heating.

FIG. 7 illustrates a power generation system including an ion transport membrane for producing an oxygen rich gas stream from air, the system also including additional steam superheating.

### DETAILED DESCRIPTION OF THE PREFERRED EMBODIMENTS

The invention comprises a low emission power generation plant that provides high efficiency and high power density. The invention integrates air separation and fuel gasification into a single heat engine, unlike conventional IGCC systems which require an additional thermodynamic cycle to recover waste heat generated.

Some disclosed IGCC systems include air separation units (ASU) to produce oxygen rich gas streams. However, the oxygen rich gas streams in those systems are used exclusively for the gasification process, not for the combustion process. The invention directly integrates the oxygen separator into the power cycle and preferably uses an oxygen rich gas stream for both the gasification and combustion steps. By using an oxygen rich gas stream for the combustion process, the combustion process operates without any significant quantity of nitrogen. As a result, the combustion temperature can be raised far above the temperature at which conventional power plants must operate to avoid nitrogen oxide formation, thereby increasing thermal efficiency and power density.

Although the single cycle power generating system will generally be described as including an oxygen separator for providing an oxygen rich gas stream from gaseous streams, such as air, if a source of substantially pure oxygen is available, an oxygen separator is not necessary.

The oxygen rich gas stream includes at least 99% oxygen and has no significant nitrogen content. As used herein “no significant nitrogen” content refers to less than 1% nitrogen, and preferable less than 0.01% nitrogen. A low nitrogen content oxygen rich gas stream allows the combustor to operate at a combustion temperature range of 3000 to 4500° F. (1650 to 2480° C.), which is far above the temperature range that a conventional power plant combustor can operate of 2200 to 2800° F. (1200 to 1540° C.). Conventional power plants have limited combustor temperatures to minimize the formation of various environmentally harmful nitrogen oxides. The ability to perform combustion at a substantially higher temperature than possible before results in a substantial increase in obtainable thermal efficiency and power density.

A gasifier is provided for generating a synthesis gas from fuel provided. The system can utilize a variety of fuels, such as coal, or other solid or liquid fuels.

The system includes a combustor for combusting a mixture including the synthesis gas or a product derived from the synthesis gas, along with the oxygen rich gas stream and a steam flow to produce thermal energy. As used herein, the term synthesis gas refers to a mixture of gases which can be used as a feedstock for a chemical reaction.

Structure is provided for converting at least a portion of the thermal energy generated in the combustor to power, or another form of energy. Energy from the system can be converted into a variety of energy forms, such as mechanical and electrical power, chemicals, high value liquid transportation fuels, such as methane, ethanol and hydrogen, refrigeration, steam, and heat. The proportions of the various energy forms produced can be easily varied.

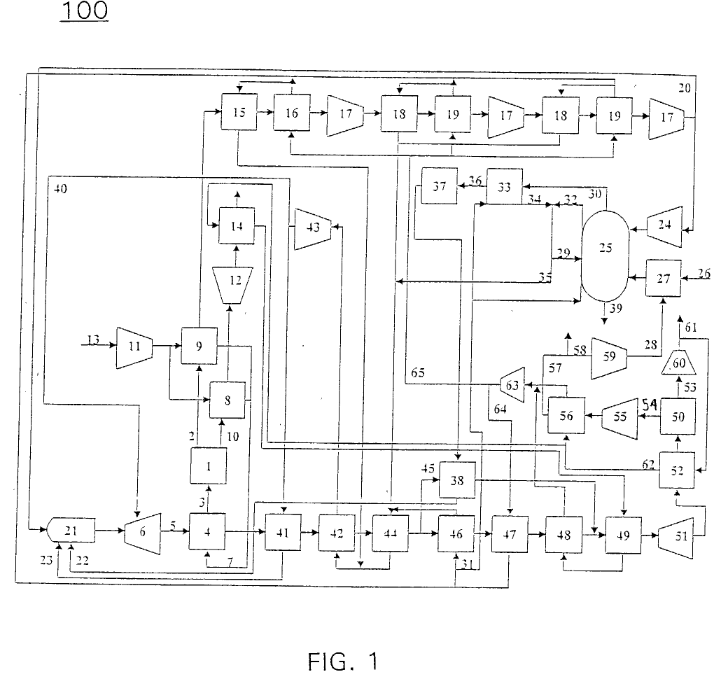

A first embodiment of the invention is the power generation system 100 shown in FIG. 1. In this embodiment, an ion transport membrane (ITM) air separation unit (ASU) (1) is used as an oxygen separator to produce an oxygen rich product stream (2) from an incoming oxygen containing gaseous stream, such as air stream (3). The ITM requires both a high temperature of about 1470 to 1650° F. (800-900° C.) for proper membrane operation and a pressure differential across the membrane, such as 200 to 400 psia to separate oxygen from the air.

The ion transport membrane (ITM) air separation unit (ASU) (1) operates by driving the oxygen across a membrane by the oxygen partial pressure difference between the air side and the product side. Heat required for membrane operation can be provided to the incoming ITM air via an air preheater (4) that receives heat from the hot gases (5) exiting the turbine expander (6) which passes the heat to the air stream (7) to be sent to the ASU ITM (1). Regenerative heat exchangers (8,9) can then be used to preheat the air sent to the ITM air preheater (4) with the oxygen product (2) and depleted air (10) streams from the ASU ITM (1) to minimize the heat removed from the turbine exhaust flow (5).

The ITM ASU (1) normally operates at a pressure above atmospheric pressure on the feed air/depleted air side, and therefore a compressor (11) is generally used to compress atmospheric air (13) fed to the regenerative heat exchangers (8, 9). A turbine expander (12) can be used to extract excess energy from the depleted air stream prior to discharge. Additionally, this turbine exhaust flow may be used for feedwater heating (14) prior to release to the environment.

After leaving the regenerative air heater (9), the oxygen product stream (2) from ASU (1) is preferably first cooled by a high pressure steam generator (15) and a feedwater heater (16), and is then compressed in an oxygen compressor (17) to a pressure range corresponding to an oxygen temperature below that of significant oxidation concerns in the oxygen compressor, but above that of steam temperature requirements of the intercoolers. Oxygen compressor (17) can be intercooled at one or more locations by additional high pressure steam generators (18) and feedwater heaters (19). Intercooler locations, feedwater supply temperature, and feedwater/steam return temperatures are preferably set for the best match of the heat rejection profile of the turbine expander exhaust flow as it exits the ITM ASU heat exchanger (4). For example, enough steam can be produced by the intercoolers to allow maximum heat rejection of the turbine expander exhaust flow.

After exiting the oxygen compressor (17), the pressurized oxygen rich flow can be split into two flows. One of these flows (20) can be provided to the combustor (21) for combustion with incoming syngas fuel (22) derived from the gasification process. The oxygen flow provided to the combustor (21) is preferably equal to approximately the amount needed for stoichiometric combustion with the particular fuel used.

Steam (23) is also provided to the combustor. Steam (23) can be used to regulate the combustion process temperature, the internal combustor temperature profile, and the combustor exit temperature by varying its flow rate. The combustor (21) may also be cooled by oxygen, steam, and/or fuel flow.

The second oxygen rich flow from the oxygen compressor (17) is compressed further in another oxygen compressor (24) prior to being sent to the gasifier (25). If a solid fuel, such as coal is used, the solid fuel can include a sorbent material. The solid fuel is preferably dried and ground to a small particle size and then fed (26) into the fuel handling system (27). Fuel handling system (27) uses a gas composed primarily of carbon dioxide along with some water vapor (28) as the motivational fluid for the solid fuel particles to transport them to the gasifier (25). Alternatively, if the fuel is a liquid, a liquid fuel transportation system can be used to bring the fuel to the gasifier.

The gasifier (25) is a partial oxidation reactor that can also receive the compressed oxygen from the gasifier oxygen compressor (24) as well as steam (29) produced from heat rejected from the gasifier (25) and/or syngas cooler (33). The product of the gasifier (25) is a high temperature synthesis gas (30) composed primarily of hydrogen and carbon monoxide. The gasifier (25) product can also include small quantities of carbon dioxide, water vapor, particulates, acid gases, and other impurities.

High pressure feedwater (31) can be used to cool the gasifier (25) and produce high pressure steam (32). The syngas (30) exiting the gasifier can be first cooled in the syngas cooler (33) which generates steam from the same high pressure feedwater supply (31) that is also fed to the gasifier (25). The steam (34) produced by the syngas cooler (33), along with any steam (32) produced by the gasifier (25), can be mixed together and a portion of the steam (29) is taken for injection into the gasifier. The remainder of the steam (35) can be sent to the power cycle.

The syngas (36) exiting the syngas cooler (33) is then preferably cleaned of particulates, sulfur, alkali, and other unwanted components (37), such as filters and scrubbers, and transported to the syngas heater (38) prior to its introduction into combustor (21). Solid waste (39) is removed generally by slagging from the gasifier (25), processed, and prepared for disposal.

The combustor (21) combusts oxygen (20) with the syngas (22) along with steam (23). The steam is used primarily to control the combustor exit temperature. Combustion temperatures can be higher than conventional systems and be as high as approximately 4500° F. (2480° C.) since oxygen (20) lacks significant quantities of nitrogen. The ability to operate at higher combustion temperatures raises thermal efficiency and power density.

The hot gases then can pass though the turbine expander (6) which is cooled by steam (40). The turbine expander (6) extracts mechanical power from the thermal energy of the steam flow (40), and exhausts the steam flow (5) into the ITM air preheater (4). Typically the turbine expander (6) exhausts at a pressure close to, but slightly above, ambient air pressure, to both minimize leakage concerns and reduce the size of the downstream heat exchanger components (41, 42, 44, 46, 38, 47, 48, 49).

Since the ITM air preheater (4) operates at a high temperature, such as 1470 to 1650° F. (800-900° C.), the exhaust flow from the ITM air preheater (2) is still at temperatures above those typically found in heat recovery steam generators of conventional gas turbine combined cycles. In order to best use this additional available heat, a high pressure steam turbine (15) and associated high pressure feedwater/steam loop can be incorporated into the cycle.

After exiting the ITM air preheater (4), the heat of the turbine exhaust gases, which are primarily water and carbon dioxide, can be used to generate steam and heat feedwater as well as fuel. The first heat exchanger after the ITM air preheater (4) shown is a steam superheater (41) that can perform the final heating of combustor injection steam. The steam then arrives at the main steam superheater (42) which heats the steam prior to its introduction into the high pressure steam turbine (43). After passing through another superheater (44), the turbine exhaust flow can be split into two streams. One of these streams (45) can be used to heat the syngas fuel in the fuel heater (38). The other stream can be used to generate high pressure steam in steam generator (46), and then to heat high pressure feedwater in an economizer (47). The turbine exhaust flow then can proceed to low pressure economizers (48, 49).

Between economizer (48) and economizer (49), the portion of turbine exhaust flow used for fuel heating can be mixed back into the portion used for steam generation and feedwater heating. At this point, the turbine exhaust flow may begin to form water condensate as it is cooled. Such condensate is generally removed from the gas path shortly after its formation and sent to the condenser (50) for recycling.

The turbine exhaust flow exiting the economizer (49) can then be expanded to sub-atmospheric pressure in a low pressure expander (51). Since the flow through this expander is primarily steam with some carbon dioxide, and this steam is nearing (or at) the condition at which water condensate will form, this expander is similar to a conventional low pressure condensing steam turbine. The exhaust pressure of this turbine expander (51) is determined by peak performance and fuel composition, in that the condenser (50) which follows the expander must be able to create enough condensate by cooling the flow with the cooling medium (either water or air) to satisfy feedwater recirculation requirements dictated by the needed gasifier steam flow and the desired combustion firing temperature. The exhaust pressure level of turbine expander (51) is therefore dependent upon the level of non-condensable gases such as carbon dioxide that are present in the turbine exhaust flow.

After exiting low pressure turbine (51), the exhaust flow can enter a condensate preheater (52) before proceeding to the condenser (50), which preferably uses a separate cooling water (or ambient air) circuit to cool the turbine exhaust flow and to condense water. The quantity of condensed water produced is generally sufficient to supply the recirculation flow requirements of the entire system 100.

Exiting the condenser (50) are two streams. One of these streams is the uncondensed gases (54) that can be sent to a stack gas compressor (55) for compression to a pressure which is above atmospheric pressure. This flow is composed mostly of carbon dioxide, with some water, and may be either released to the environment or compressed to a pressure sufficient for sequestration, such as by well injection.

When the stack gas is released to the environment, the gas exiting the stack gas compressor (55) is at a pressure slightly higher than ambient, and can first be used to heat feedwater in a stack gas cooler (56). Again, the cooling of the gas in this heat exchanger may cause condensate to form, which can either be released to the environment or returned to the condenser (50). The flow then leaves the stack gas cooler (56) and a portion of the stack gas flow (57) and can be split off in a separate flow (58), compressed in an intercooled compressor (59) that also heats feedwater (feedwater supply to compressor (59) not shown in FIG. 1) and used to produce output flow (28). Flow (28) can be sent to the fuel handling system (27). The remaining stack gas can be released to the environment. For liquid fuels, the fuel handling flow (28) may not be required.

For the case of sequestration of the stack gas, the stack gas compressor (55) exhausts at a much higher pressure corresponding to that needed for well injection, and this compressor (55) may be intercooled to reduce its power requirements and heat feedwater (not shown in FIG. 1). Again, condensate water may form and can be removed from the flow, increasing the concentration of carbon dioxide in the stack gas. Again, a portion of the flow (57) exiting the stack gas cooler (56) can be split off in a separate flow (58), compressed further (59), and sent (28) to the fuel handling system (27). The remaining stack gas can be discharged into a well for sequestration of the stack gas. As before, for liquid fuels, the fuel handling flow (28) may not be required.

The other stream exiting the condenser (50) is the condensate (53) that is first pumped by a condensate pump (60). Excess water above that needed for recirculation in the plant can be removed from the pump exit flow and either discharged to the environment (61) or delivered as a product. The remaining flow is then preferably heated in the condensate preheater (52). The preheated condensate flow (62) can then be split to recover heat from the stack gas in the stack gas heater (56) and the ITM turbine expander feedwater heater (14). The portion of preheated condensate flow (62) exiting the stack gas heater (56) can be sent to the main high pressure feedwater pump (63) inlet.

An alternative arrangement not shown in FIG. 1 can be used to more efficiently process syngases which require relatively high low pressure turbine expander discharge pressures. In this case, the heat available from the stack gas heater (56) may be low enough that the exiting feedwater is instead sent to a turbine exhaust flow economizer (49, 48).

The portion of preheated condensate (62) exiting the ITM turbine expander exhaust feedwater heater (14) can be sent to economizer (49), and then to economizer (48) before being sent the main high pressure feedwater pump (63) inlet. The mixing point for the preheated condensate exiting the stack gas heater (56) results in this flow bypassing the turbine exhaust flow economizers (48, 49). This is because the condensate exit temperature from the stack gas cooler is generally at a higher temperature than that exiting the ITM turbine expander exhaust feedwater heater (14).

High pressure feedwater exiting the main high pressure feedwater pump (63) can then be split into two streams. One stream (64) can be sent to the turbine exhaust flow high pressure feedwater economizer (47), while the other stream (65) can be split further, sent through the oxygen intercooler feedwater heaters (19) and the oxygen cooler feedwater heater (16), mixed back together, and then mixed with the heated feedwater exiting the turbine exhaust flow high pressure feedwater economizer (47). A portion of this flow (31) can then be split off and sent to the gasifier (25) for use in steam generation by the gasifier and/or syngas cooler (33), while the remainder can be sent to the turbine exhaust flow high pressure steam generator (46).

A portion of each flow exiting the oxygen intercooler feedwater heaters (19) can be separated and sent to the oxygen high pressure steam generators (18). The exiting high pressure steam flows are preferably mixed together and then mixed with both the return steam (35) generated by the gasifier (25) and/or syngas cooler (33) and the steam exiting the turbine exhaust flow high pressure steam generator (46) before proceeding to the turbine exhaust flow steam superheater (44).

A portion of the flow exiting the oxygen cooler feedwater heater (16) can be separated and sent to the oxygen high pressure steam generator (15). The exiting high pressure steam flow can be mixed with the flow exiting the turbine exhaust flow steam superheater (44). This mixing point is selected for the steam since the steam flow exiting the oxygen high pressure steam generator (15) is generally at a higher temperature than that exiting the oxygen intercooler high pressure steam generators (18). After mixing, the flow preferably proceeds to the next turbine exhaust flow steam superheater (42) for additional superheating.

The high pressure, high temperature steam exiting the turbine exhaust flow steam superheater (42) can then be sent to a conventional high pressure steam turbine (43) to extract energy. The steam exiting the steam turbine (43) can be split into two streams. One stream (40) can be sent to the turbine expander (6) for cooling of the turbine hot parts. The other stream can be sent to the turbine exhaust flow steam reheater (41) for final heating to high temperature prior to its injection (22) into the combustor (21). The turbine cooling steam (40) may also be used for cooling of the hot combustor parts as well (not shown in FIG. 1).

The system 100 shown in FIG. 1 can produce mechanical and/or electrical power through use of the turbine expanders and electrical generators. The system 100 can also provide heat from waste streams and/or any of the available high temperature flows. Refrigeration can be provided through cooling of the ITM turbine inlet flow prior to expansion, either using the whole flow or only a portion of the flow. System 100 can also provide chemicals such as CO₂ from the stack gas, steam and/or water from multiple locations in the steam/water portion of the system, as well as hydrogen, carbon monoxide, and/or liquid fuels by further processing of a portion of the syngas.

There exist many variants of system 100 that will be apparent to those skilled in the art. For example, minor system modifications can be made to support related systems, such as systems utilizing alternative air separation methods, certain alternative fuels for combustion as well as to optimize the type and quantity of desired products, and to satisfy emission limitations.

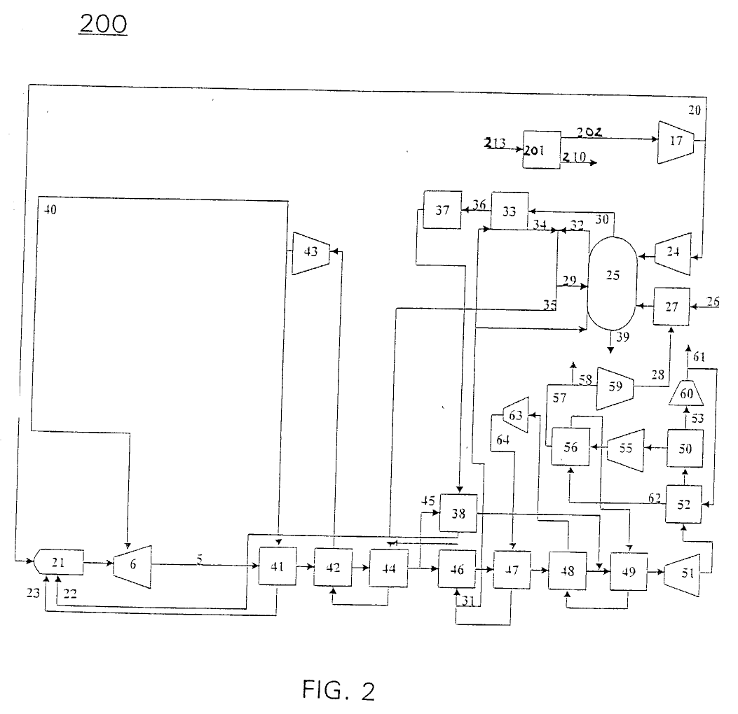

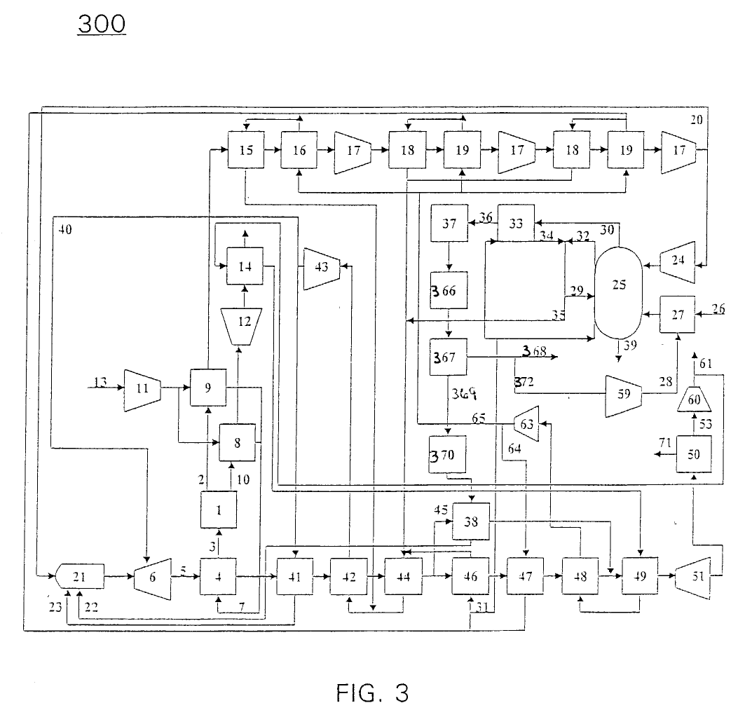

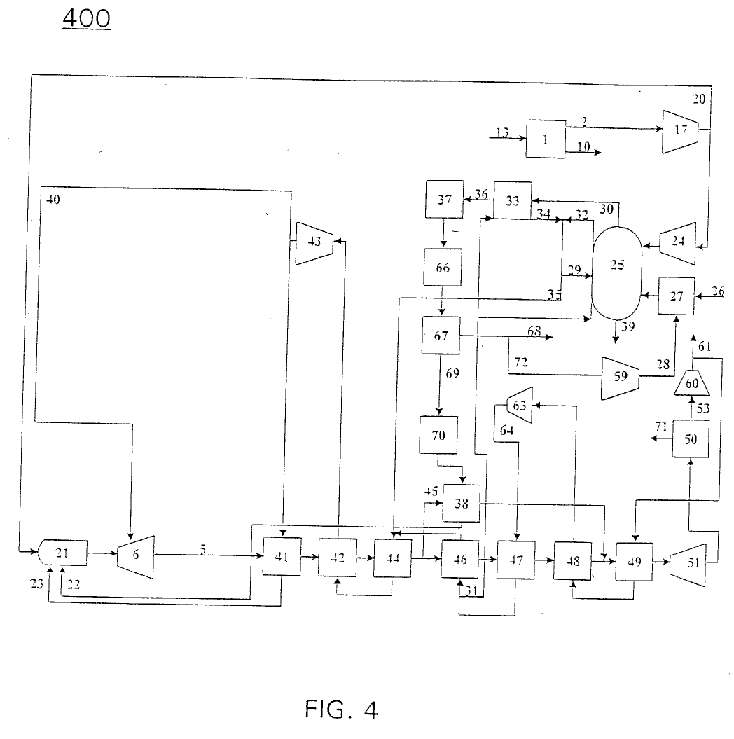

Three major configuration variations from system 100 are described below. These variations are generally related to an alternative air separation technique (FIG. 2), additional fuel processing (FIG. 3), and a combination of the same (FIG. 4).

FIG. 2 shows system 200 which replaces the ion transport membrane air separation unit (1) shown in FIG. 1 with a conventional cryogenic air separation unit (201). This method of air separation is less integrated into the power system as compared to ion transport membrane separation technology used in system 100. For example, system 200 does not require the ITM air preheater (4) or the integrated high pressure feed air system (11, et al.) shown in FIG. 1.

The cryogenic air separation unit (201) can take ambient air (213) and cryogenically separates oxygen (202) from the other air components (210). Although not shown, the cryogenic air separation unit (201) can produce high purity carbon dioxide, water, nitrogen, and argon products for commercial use via additional distillation and recovery equipment. This is not shown in FIG. 2, but would be indicated by additional product streams leaving the air separation unit (201) in addition to (or in place of) the oxygen depleted air stream (210). In addition, the cryogenic air separation unit (201) can be designed to provide extra refrigeration capabilities as needed.

Since the cryogenic air separation technology is typically a stand-alone plant, feedwater heating capabilities using waste heat are limited and none are indicated in FIG. 2. The stack gas condensate preheater (56) must now generally take all the condensate flow (62), resulting in a lower condensate exit temperature from this heat exchanger and therefore requiring it to be sent to the turbine exhaust flow economizers (49, 48) for additional heating prior to being pumped to high pressure by the feedwater pump (63).

Another feature of the cryogenic air separation technology is that cryogenic liquid pumps within the air separation unit (201) can be used to produce high pressure oxygen product. As a result, the additional compression of the (gaseous) oxygen product stream (202) from the air separation unit (201) required by the power system is generally far less than systems using the ion transport membrane technology, and therefore little or no precooling or intercooling is generally used. The high pressure oxygen product (202) can be compressed further using an oxygen compressor (17). This results in dramatically lower oxygen compression power requirements than that needed for ion transport membrane air separation and results in a high pressure oxygen flow at a relatively low temperature. As with the system shown in FIG. 1, additional oxygen compression (24) is generally required for the oxygen sent to the gasifier (25).

While cryogenic air separation has a large oxygen compression power advantage over the ion transport membrane technology, it generally has additional resource requirements that the ITM technology does not. The largest resource from the standpoint of performance impact is the electrical load required by the cryogenic air separation unit to operate its compressors, pumps, and other components. Additionally, the cryogenic air separation unit (201) may require steam and/or cooling water from the power plant, neither of which are shown in FIG. 2.

Operation of system 200 will generally result in higher emissions as compared to system 100 shown in FIG. 1. The emissions produced by system 200 is generally higher than system 100 because the cryogenic distillation process performed by the cryogenic air separation unit (201) generally results in a small amount (typically 1-5%) of nitrogen in the oxygen rich gas stream produced, unlike the nearly 100% pure oxygen produced by the ion transport membrane technology. This generally contributes to the formation of nitrogen oxides in the combustor (21), and therefore can increase the emissions of system 200.

System 300 is another configuration variation which is shown in FIG. 3. Compared to the system shown in FIG. 1, this system incorporates additional fuel processing to convert the syngas into a fuel consisting almost entirely of hydrogen gas. The syngas cleanup process (37) shown in FIG. 1 includes a condenser to remove water from the syngas flow. In FIG. 3, the syngas cleanup process (37) does not include this step, as the snygas must is first sent to a shift reactor (366) which converts virtually all of the carbon monoxide in the syngas to carbon dioxide and hydrogen gas via the carbon-water shift reaction. This reaction generally requires sufficient water as superheated steam in the shift reactor (366) to complete this reaction. The fuel then continues to the pressure swing adsorber (367), which separates the carbon dioxide (368, 372) from the fuel (369).

Although not shown in FIG. 3, it is possible that steam from superheater (42) may be requited in the shift reactor to assure sufficient steam content. In the extreme case of use of all superheater (42) steam, the entire high pressure steam turbine system can be eliminated.

The carbon dioxide (368, 372) leaving the pressure swing adsorber (367) is at a pressure lower than the syngas as this is required to release the carbon dioxide from the adsorber beds, and some of this carbon dioxide (72) can be taken for compression (59) and delivery (28) to the fuel handling system (27) as a transport medium for the fuel. This flow (372) may be cooled prior to and during compression to reduce compressor power requirements and operating temperature, and also provide feedwater heating.

The carbon dioxide flow (368) remaining after removal of the fuel handling flow (372) may be discharged directly to the environment or compressed further for sequestration. In the case of discharge to the environment, the flow may be expanded to produce power if the pressure swing adsorber (367) carbon dioxide flow discharge pressure is significantly above ambient pressure, and then may be cooled in a feedwater heater prior to discharge. Neither this expander nor the feedwater heater is shown in FIG. 3.

If the carbon dioxide flow is to be sequestered by well injection, then all of the pressure swing adsorber (367) carbon dioxide discharge flow can follow the process described in the previous paragraph for the fuel handling flow (372), and the carbon dioxide to be sequestered (368) is removed via an interstage bleed in the carbon dioxide compressor (59) or taken from its discharge (not shown).

After exiting the pressure swing adsorber (367), the fuel can be sent to a condenser (370) for removal of water from the fuel. At this point, the fuel consists almost entirely of hydrogen gas, though other species such as methane and other gaseous impurities may be present in small quantities. A portion of the fuel flow exiting the condenser (370) may be taken for production of hydrogen and/or liquid fuels by further processing. The remaining fuel from the condenser (370) can then be sent to the fuel heater (38), and then the combustor (21). Significantly, since the fuel supplied to combustor (21) is almost entirely hydrogen, the combustion products leaving combustor (21) consist almost entirely of water, which is in the form of superheated steam.

Since the turbine exhaust gas is almost entirely water (again, as superheated steam), the low pressure expander (51) can be substantially identical to low pressure condensing steam turbines that are used in conventional low pressure steam condensing processes. Additionally, since the quantity of non-condensable gases in the working fluid is far below that of the system in FIG. 1 and close to that of conventional low pressure condensing steam turbines, peak performance can be obtained at a low pressure expander (51) discharge pressure below that of the system shown in FIG. 1, and more typical of conventional low pressure condensing steam turbines. The low level of non-condensable gases in the low pressure expander (51) can also allow for operation at this low discharge pressure while still generally producing sufficient condensate in the condenser (50) to meet the feedwater recirculation requirements for system 300.

The condensate preheater (52) of FIG. 1 can be eliminated in system 300 due to two primary reasons. First, the non-condensable gases as condensation occurs is minimized across a much narrower temperature range. Second, as the non-condensable gases that do exist in flow (71) are in small quantities, they can be removed from the condenser by use of a conventional steam jet air ejector.

The steam jet air ejector and its input steam flow are not shown in FIG. 3, but would consist of using a flow of steam at sufficient pressure from elsewhere in the system to eject the non-condensables from the condenser (50). The stack gas compressor (55) and stack gas feedwater heater (56) from FIG. 1 are also eliminated. Also note that the eliminated components from FIG. 1 (condensate preheater (52), stack gas compressor (55), stack gas feedwater heater (56)) may be only be eliminated from a process standpoint, since the power plant may still have these components available for use for operation with conventional syngas fuel, but these components may be bypassed when operating with the shift reactor (366) in service.

The entire condensate flow exiting the condenser (50) in FIG. 3 can be sent to the ITM turbine exhaust feedwater heater (14). The condensate flow can then be sent to the turbine exhaust flow economizer (49).

System 400 is another configuration variation which is shown in FIG. 4. System 400 uses the cryogenic air separation technology shown in FIG. 2 to produce the oxygen rich gas stream along with the additional fuel processing shown in FIG. 3. Compared to the system shown in FIG. 2, the changes to implement system 400 are the additional changes in going from the system shown in FIG. 1 to the system shown in FIG. 3. That is, system 400 contains both the changes described above to go from the system shown in FIG. 1 to the system shown in FIG. 2, and those described to go from the system shown in FIG. 1 to the system shown in FIG. 3, except, there is no ITM turbine exit feedwater heater required in system 400 as all condensate exiting the condensate pump (60) can be sent directly to the turbine exhaust flow economizer (49).

Numerous variations can be made to systems 100, 200, 300 and 400 shown in FIGS. 1-4. For example, for each of these systems, waste heat obtainable from syngas cooler (33), fuel cleaning process (37) and fuel condenser (70) may be used for additional feedwater heating. Feedwater may be fed to these components in series and/or in parallel, as determined by the waste heat's maximum available temperature. The feedwater source may be the condensate pump (60), the condensate preheater (52), the stack gas feedwater heater (56) if it exists, the ITM turbine exhaust feedwater heater (14) if it exists, or the turbine exhaust flow economizers (49, 48), or a portion of the exit flow from the feedwater pump (63). Likewise, the mixing location chosen for the return flow from these feedwater heaters is determined by the temperature of the feedwater exiting the heaters. In a similar fashion, slag exiting the gasifier may provide feedwater heating via a slag bath cooler.

In addition, for systems 100, 200, 300 and 400 shown in FIGS. 1-4, the heat of the syngas cooler (33), fuel cleaning process (37), fuel condenser (70), and slag bath cooler (not shown) may be used to heat the product fuel gas prior to its introduction to fuel heater (37), or even as a replacement of this fuel heater. For systems 100 and 300 which include ion transport membrane air separation technology, these systems may be modified to provide refrigeration.

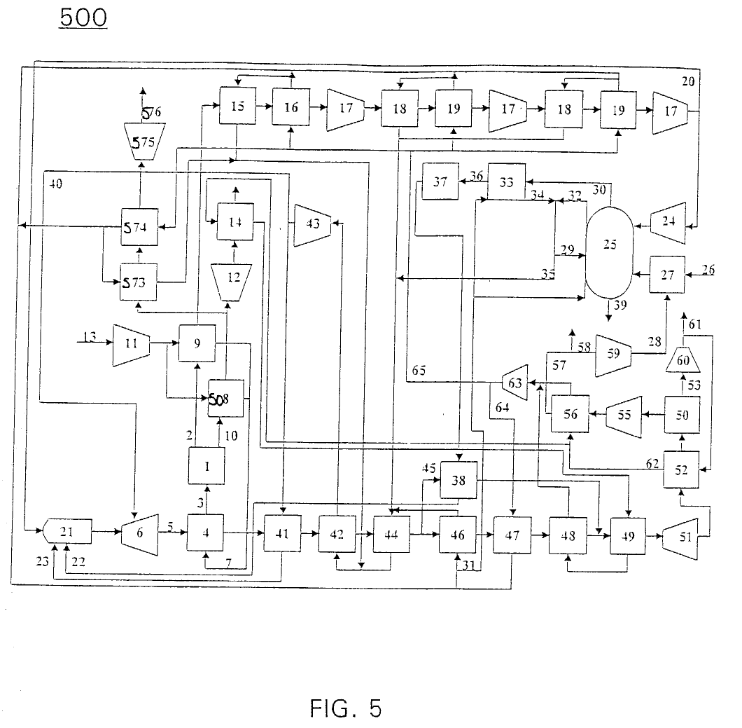

FIG. 5 shows system 500 which applies this concept to system 100 shown in FIG. 1. A portion of the depleted air exiting the ITM air regenerator (508) may be separated and cooled by a high pressure steam generator (573) and/or a feedwater heater (574). The amount of cooling and selection of either or both a steam generator (573) and/or a feedwater heater (574) depends upon the depleted air exit temperature from the ITM depleted air regenerator (508) and the desired temperature of the coolant (576) to be delivered for refrigeration duty.

The depleted air can then enter an expander (575), which can expand the depleted air to a lower pressure. This expansion results in an expander (575) exit temperature below ambient. This exit flow (576) can be used for refrigeration duty.

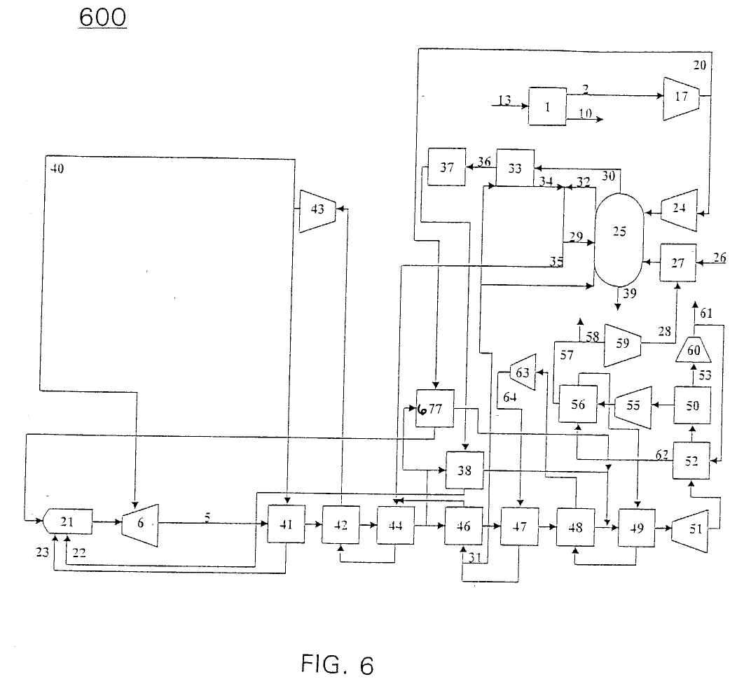

For systems 200 and 400 shown in FIGS. 2 and 4 which include cryogenic air separation technology, these systems may be modified to provide for increased thermal efficiency by heating of the product oxygen to 300 to 1000° F. (150 to 540° C.), or more, from the air separation unit. System 600 shown in FIG. 6 is a modification of system 200 shown in FIG. 2. Product oxygen (20) exiting the oxygen compressor (17) may be sent to an oxygen heater (677) that is in parallel with the fuel heater (38). In this way, the oxygen recuperates additional heat back to combustor (21), thereby increasing the thermal efficiency of system 600 as compared to system 200.

For each of systems 100, 200, 300 and 400 shown in FIGS. 1-4, the high pressure water/steam loop may be eliminated if steam preheat temperatures prior to injection into the combustor (21) are allowed at levels significantly higher than those found (e.g. 1400° F. (760° C.)) in state-of-the-art steam power plants.

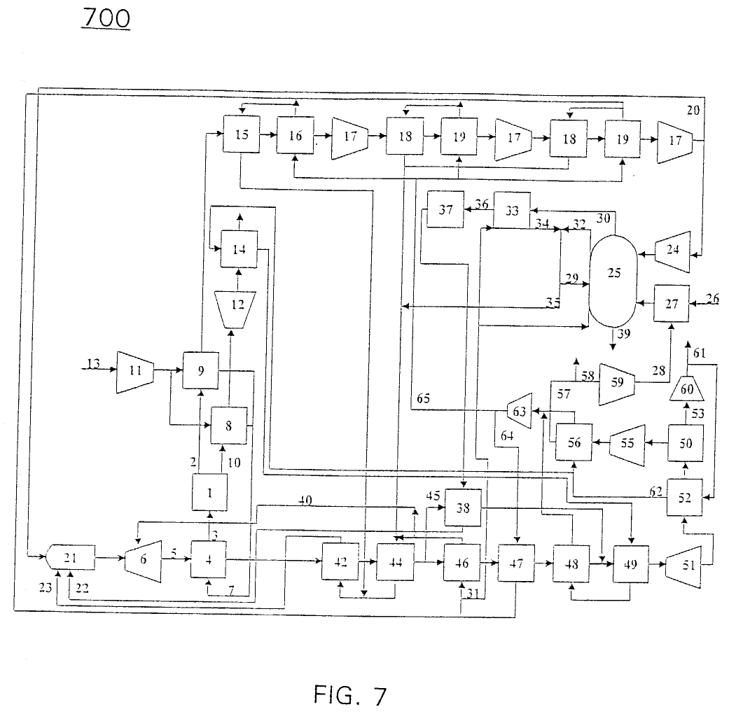

System 700 shown in FIG. 7 is this concept applied to the system of FIG. 1. The feedwater pump (63) discharge pressure can be reduced, and the high pressure steam turbine (43) and steam reheater (41) can be eliminated. The steam superheater (42) steam exit temperature can be significantly higher than that of the system in FIG. 1. Additionally, in system 700, the turbine cooling steam (40) must now generally be taken from the steam exiting the turbine exhaust flow steam generator (46).

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

I claim:

1. An integrated gasification power generating system, comprising:
an oxygen separator for providing an oxygen rich gas stream from a gaseous mixture including oxygen, said oxygen rich gas stream including at least 95% oxygen;
a gasifier for generating a synthesis gas from at least one fuel;
a combustor for combusting a mixture including said oxygen rich gas stream, a steam flow and said synthesis gas or a product derived from said synthesis gas to produce thermal energy, and
structure for converting at least a portion of said thermal energy to another form of energy.

2. The system of claim 1, wherein said oxygen rich gas stream includes a nitrogen content of less than 1%.

3. The system of claim 1, wherein said combustor operates at a combustion temperature of at least 3000° F. (1650° C.).

4. The system of claim 1, wherein said oxygen separator comprises an ion transport membrane (ITM) air separation unit (ASU).

5. The system of claim 4, wherein said oxygen rich gas stream comprises at least 99% oxygen.

6. The system of claim 4, further comprising structure for generating a fluid capable of providing refrigeration.

7. The system of claim 1, wherein said oxygen separator comprises a cryogenic air separator.

8. The system of claim 1, further comprising a structure for converting said synthesis gas to a converted fuel, said converted fuel comprising at least 30% hydrogen gas.

9. The system of claim 8, wherein said structure for converting said synthesis gas comprises a shift reactor/pressure swing adsorber.

10. The system of claim 1, wherein said system is adapted to provide a thermal-to-electrical energy efficiency of at least 55%.

11. The system of claim 1, further comprising a structure for superheating said steam flow prior to combustion in said combustor, wherein said superheat temperature is at least 1000° F. (540° C.).

12. In an integrated gasification power generating system, a method of operating said system comprising the steps of:
providing a steam flow and an oxygen rich gas stream, said oxygen rich gas stream including at least 95% oxygen;
generating a synthesis gas from at least one fuel;
combusting a mixture including said oxygen rich gas stream, said steam flow and said synthesis gas or a product derived from said synthesis gas to produce thermal energy, and
converting at least a portion of said thermal energy into another energy form.

13. The method of claim 12, wherein said oxygen rich gas stream includes a nitrogen content of less than 1%.

14. The method of claim 12, wherein said combusting step is performed at a combustion temperature of at least 3000° F. (1650° C.).

15. The method of claim 12, wherein an ion transport membrane (ITM) air separation unit (ASU) is used to provide said oxygen stream from an incoming air stream.

16. The method of claim 15, wherein said oxygen rich gas stream comprises at least 99% oxygen.

17. The method of claim 12, wherein a cryogenic air separation unit is used to provide said oxygen rich gas stream from an incoming air stream.

18. The method of claim 12, wherein said synthesis gas comprises a hydrogen containing fuel, further comprising the step of converting said synthesis gas into a converted fuel, said converted fuel comprising 30% hydrogen gas.

19. The method of claim 12, wherein a cryogenic air separation unit is used to provide said oxygen rich gas stream from an incoming air stream.

20. The method of claim 12, further comprising the step of superheating said steam flow prior to said combusting step, wherein said superheat temperature is at least 1000° F. (540° C.).
